(19) United States
(12) Patent Application Publication
(10) Pub. No.: US 2023/0284544 A1
(43) Pub. Date: Sep. 14, 2023

(54) LAWN GROOMING DEVICE

(71) Applicant: S & B Lawn Systems Inc., Brookfield, WI (US)

(72) Inventors: Stefan Behling, Brookfield, WI (US); Steven Sprinkmann, Germantown, WI (US)

(73) Assignee: S & B Lawn Systems Inc., Brookfield, WI (US)

(21) Appl. No.: 18/183,736

(22) Filed: Mar. 14, 2023

Related U.S. Application Data
(60) Provisional application No. 63/319,405, filed on Mar. 14, 2022.

(51) Int. Cl. A01B 45/00; A01B 29/04; A01D 43/00

(52) U.S. Cl. CPC A01B 45/00; A01B 29/04; A01D 43/00; A01D 2101/00

(57) ABSTRACT

A grooming device for striping lawns includes a cover. A roller drum is rotatably connected to the cover. A frame is connected to the cover and extends away from the cover. At least one clamp is configured to adjustably secure the frame to a handle of a lawn mower. A connector for securing accessories includes an inner shell and an outer shell. A clamp insert is removably secured within an insert cavity defined between the inner shell and the outer shell.

### CROSS-REFERENCE TO RELATED APPLICATIONS

The present application claims priority of US Provisional Application No. 63/319,405, filed on Mar. 14, 2022, which is hereby incorporated by reference in its entirety.

### FIELD OF THE DISCLOSURE

The present disclosure relates to lawn care. More particularly, the present disclosure relates to a device for aesthetic lawn grooming.

### BACKGROUND

Lawn grooming devices aesthetically alter the appearance of mowed grass. Lawn striper grooming devices are used for grooming sports fields, golf greens, or ornamental gardens.

US Patent Application Publication No. 2009/0255228, entitled “Lawn Stripping Assembly” discloses a grooming device for use on a walk behind mower. The lawn grooming device includes an adjustable tow bar mounted on a lawn mower operator’s handle. A hitch member is mounted on the adjustable tow bar, and an earth engaging roller assembly is releasably coupled to the hitch member and oriented in trailing relation relative to the walk behind lawn mower.

US Patent Application Publication No. 2010/0300056, entitled “Lawn Grooming Device” discloses a lawn grooming device which includes a tow bar releasably coupled to a self-propelled overland vehicle. A drawbar support frame is mounted on the tow bar. A first weighted earth engaging roller assembly is affixed to the drawbar support frame. A drawbar is mounted on the drawbar support frame. A coupling is mounted on the drawbar and which is resiliently moveable in either the horizontal or vertical directions. A second weighted earth engaging roller assembly is mounted on the coupling and disposed in trailing relation relative to the first weighted earth engaging roller assembly.

US Patent Application Publication No. 2015/0096278, entitled “Lawncare Implements” discloses a lawncare apparatus with a cover, a rolling apparatus, and a mount. The rolling drum is rotatably supported by an axle through the rolling drum and the cover. The mount includes a V-shaped member secured to the cover and is configured to secure the roller apparatus to a lawn mower. The mount may further include a mounting bracket affixed to the apex of the V-shaped member. A brush implement, secured forward the rolling drum, includes a plurality of bristles arranged substantially perpendicular to the ground.

The disclosures of each of these references are hereby incorporated by reference in their entireties.

### BRIEF DISCLOSURE

A grooming device for striping lawns and a connector for securing accessories, including a grooming device, to a lawn mower are disclosed herein.

A grooming device for striping lawns includes a cover. A roller drum is rotatably connected to the cover. A frame is connected to the cover and extends away from the cover. At least one clamp is configured to adjustably secure the frame to a handle of a lawn mower.

The cover of the grooming device may include a shroud, a first end, and a second end. The first end and the second end are fittingly secured about the shroud. The first end and the second end are translatable relative to the shroud to adjust a length between the first end and the second end to accommodate a length of the roller drum therebetween. A brush may be secured to the cover. The cover includes a leading edge facing in a normal direction of travel. The cover includes a trailing side opposite the leading edge. The brush is secured at the trailing side of the cover. The brush may be movably connected to the cover such that a position of the brush relative to the cover is adjustable in the vertical dimension. The brush may be secured to a mounting bar with arms extending from the mounting bar, the arms pivotally connected to the cover. The roller drum may include axles that extend through the cover and the arms are pivotally connected to the cover about the axles.

In further examples of the grooming device a ball-and-socket joint movably connects the cover to the frame. The cover may include a hitch receiver and a connector on a shank. The shank may be received within the hitch receiver and the connector secures to the frame. The roller drum may include a plurality of ridges extending across the outer surface of the roller drum in an axial length dimension.

In additional examples, the at least one clamp of the grooming device includes an inner shell and an outer shell. The inner shell and the outer shell secure together to define an insert cavity therebetween. A plurality of clamp inserts, each clamp insert of the plurality of clamp inserts, are configured to be individually secured within the insert cavity. Each clamp insert of the plurality of clamp inserts includes keyed projections configured to be received within mating recesses formed in the inner shell and the outer shell. Each clamp insert includes at least two insert portions wherein each insert portion comprises at least one keyed projection. Each clamp insert of the plurality of clamp inserts defines an interior bore, wherein a perimeter of the interior bore is different between each of the plurality of clamp inserts. The at least one clamp further includes a movable clip rotatably secured to the outer shell. The movable clip and the outer shell each include mating teeth which releasably engage to secure the movable clip to the outer shell at an angular orientation.

A clamp for securing an accessory to a lawn mower includes an inner shell and an outer shell. The inner shell and the outer shell secure together to define an insert cavity therebetween. A plurality of clamp inserts each configured to be individually secured within the insert cavity. Each clamp insert of the plurality of clamp inserts defines an interior bore. A perimeter of the interior bore is different between each of the plurality of clamp inserts. A movable clip is rotatably secured to the outer shell.

In further examples of the clamp, each clamp insert of the plurality of clamp inserts includes keyed projections configured to be received within mating apertures formed in the inner shell and the outer shell. Each clamp insert includes at least two insert portions wherein each insert portion includes at least one keyed projection.

### BRIEF DESCRIPTION OF THE DRAWINGS

FIG. 1 is a perspective view of a lawn grooming device.

FIG. 2 is a sectional view of an example of a lawn grooming device.

FIG. 3A is a perspective view of an example of a roller drum.

FIG. 3B is a sectional view of the roller drum of FIG. 3A taken along line 3-3.

FIG. 4 is a perspective view of a clamp.

FIG. 5 is an exploded view of the clamp.

FIG. 6 is an interior view of the movable clip of the clamp.

FIG. 7 is an interior view of the inner shell of the clamp.

FIG. 8 is an interior view of the outer shell of the clamp.

FIGS. 9A-C depict a first example of a clamp insert.

FIGS. 10A-C depict a second example of a clamp insert.

FIGS. 11A-C depict a third example of a clamp insert.

FIGS. 12A-C depict a fourth example of a clamp insert.

### DETAILED DISCLOSURE

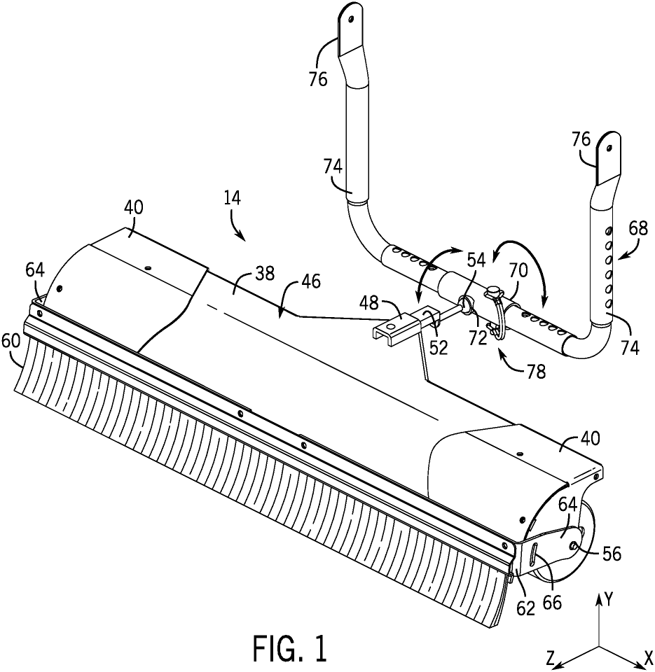

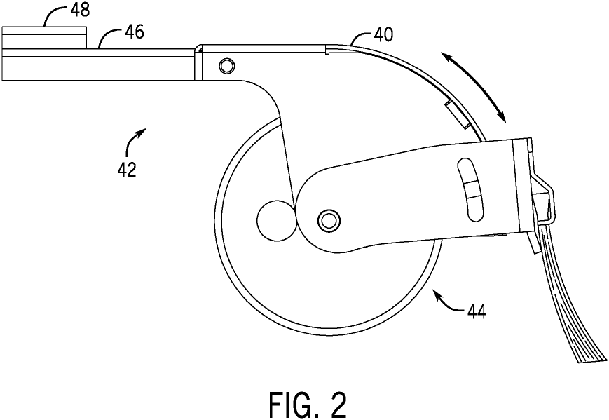

FIG. 1 is a perspective view of a lawn grooming device 10. The lawn grooming device is designed for use with a mower, which preferably is a conventional walk-behind style mower as is commonly used for residential lawn grooming. However, configurations of the lawn grooming device 10 as disclosed herein may further be used in combination with powered ride-upon mowers, or used with an autonomous or remote-controlled mowers as well.

The inventors have discovered that a challenge to prior lawn grooming solutions in this market segment is the wide array configurations and available attachment points to connect the grooming device 10 to the mower. Thus, the presently disclosed solutions provide a flexible configuration and arrangement for attachment of the grooming device 10 to mowers, while establishing an effective positional relationship between the grooming device 10 and the mower to achieve intended grooming effects.

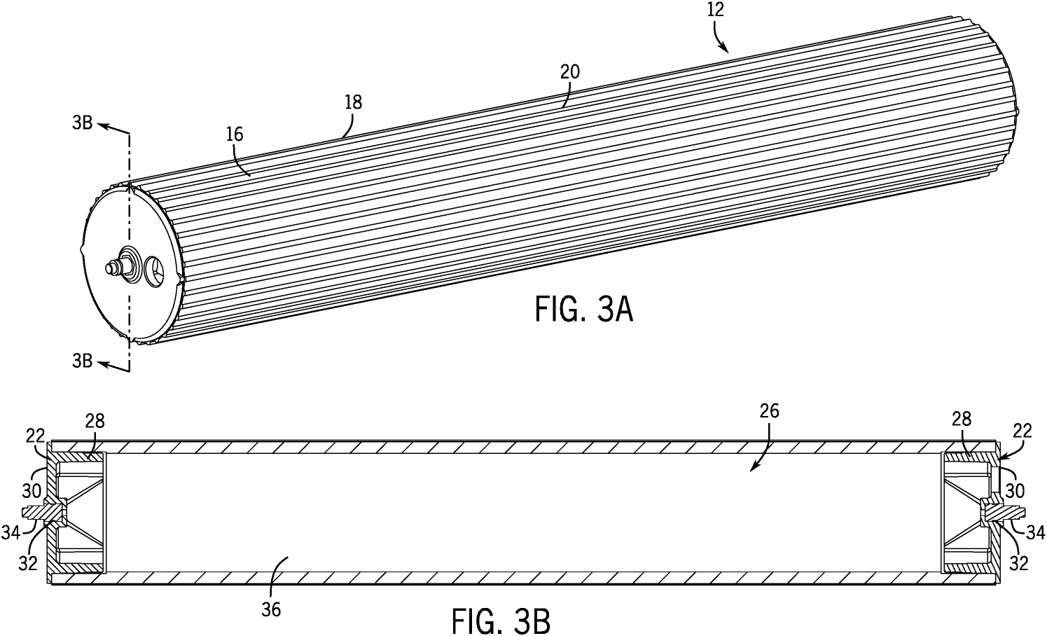

The device 10 includes a roller drum 12 which is rotatably secured within a cover 14. FIGS. 3A and 3B provide detailed depictions of the roller drum 12. FIG. 3A is a perspective view of the roller drum 12 and FIG. 3B is a cross sectional view taken along line 3-3. The roller drum 12 includes an outer cylindrical member 16 which is exemplarily constructed of a polymer material and includes a plurality of ribs 18 on an outer surface 20 of the roller drum cylindrical member 16. End caps 22 are secured to either end of the cylindrical member 16, defining an open interior 26. The end cap 22 includes a shoulder 28, inset from a face 30 of the end cap 22, the shoulder 28 is received within the cylindrical member 16 to connect the end caps 22 to the cylindrical member 16. In use, the open interior 26 is filled with sand or another flowable or granular material having a comparatively high density such that the mass of the roller drum can be greatly increased by filling the open interior 26 such material. In an example, at least one end cap 22 includes a port 24 through which the material can be introduced into the open interior 26.

The end caps 22 include sockets 32 which respectively retain axles 34 therein. The sockets 32 and the axles 34 are centered on the rotational axis 36 of the roller drum 12. The axles 34 pivotally attach to the cover 14. The roller drum 12 rotates about the axis 36 within the cover 14. In use, the mass of the roller drum 12 and the ribs 18 across the outer surface of the roller drum operate to bend blades of grass in the direction of travel of the grooming device, producing a visual striping effect on the grass.

The cover 14 may include a shroud 38 and ends 40. The ends 40 are shaped to nestingly fit over the shroud 38 and the ends include an aperture 56 that receives an axle 34 of the roller drum 12. The ends 40, being separate components from the shroud 38 are translatable relative to the shroud 38. This may facilitate assembly of the roller drum 12 within the cover 14. The ends 40 are secured by one or more fasteners to the shroud 38 to define a width of the grooming device. In this manner, the cover 14 is adjustable to accommodate a range of widths of roller drums 12, for example between 20-30 inches, although lesser or greater roller drum widths will be recognized as being within the present disclosure. The cover 14 is exemplarily curved about a radius from the axis 36. A leading edge 56 of the cover 14 defines a leading opening 42, which is exemplarily directed towards the mower to which the grooming device 10 is secured and which is also generally the direction of travel for the grooming device 10. The leading opening 42 is opposite the curved portion of the cover 14. The curved portion of the cover 14, terminates at a position above a bottom of the roller drum 12, or that portion of the roller drum which during operation would presently be in contact with the ground. This leaves a trailing opening 44 generally opposite the leading opening 42.

The grooming device 10 further includes a brush 60 connected to a mounting bar 62. The mounting bar 62 is pivotally connected to the cover 14 at the aperture 56. In an example, the arms 64 of the mounting bar 62 are pivotably connected about each of the axles 34 extending from the roller drum 12. The mounting bar 62 and the brush 60 connected to the mounting bar 62 are thus pivotable relative to the cover 14 and the roller drum 12. In effect, this provides for a positional adjustment of the brush 60 relative to the trailing opening 44 and the ground upon which the roller drum 12 rests. The position of the mounting bar 62 and the brush 60 relative to the cover 14 and the roller drum 12 is releasably fixed by at least one fastener 66, which is exemplarily a threaded fastener. In operation, the brush 60 helps in the lawn grooming process by evening and spreading out any clumps of cut grass left by the mower. The brush 60 further reinforces the bending and direction of the blades of grass by the roller drum 12.

A portion 46 of the shroud 38 is tangential to the curve of the cover and extends forward of the leading opening 42. A receiver hitch 48 is positioned on this portion 46 may receive a hitch 50. The hitch 50, as depicted in FIG. 1, includes a shank 52 and a ball 54, as will be described in further detail herein.

The grooming device 10 includes a support frame 68 that connects to the mower. In examples, the support frame 68 is configured and dimensioned in a manner such that the grooming device 10 may be used in conjunction with any of a variety of other known mower attachments or accessories, for example, but not limited to aerators, dethatchers, blowers, baggers, mulchers, or curb/edge trimmers. The support frame 68 may include a horizontal bar 70 which includes a socket 72 in which the ball 54 is received, forming a ball-and-socket joint 78. In this example, the ball-and-socket joint 78 between cover 14 and the frame 68 enables three-axis freedom for the grooming device to trail the mower while maintaining contact between the roller drum 12 and the ground. Elbows 74 adjustably connect to the horizontal bar 70 to adjust the width of the support frame 68 to match a corresponding width between handles or other attachment points on a mower. Arms 76 are also adjustably connected to the elbows 74. The adjustable connection between the arms 76 and the elbows 74 accommodate a length between the handles or other attachment points on the mower and the horizontal bar. In examples, the adjustable connections of the support frame 68 may include apertures and locking detents while threaded fasteners, locking pins, or other types of connects are recognized within the scope of the present disclosure.

The connection between the support frame 68 and the handles or other attachment points of the mower are important to maintain an established position and orientation between the grooming device 10 and the mower to produce a consistent aesthetic effect on the mowed grass. A new clamp 80 is disclosed herein to provide improved connection between the grooming device 10 and a mower through a greater variety of mower handle or attachment point configurations.

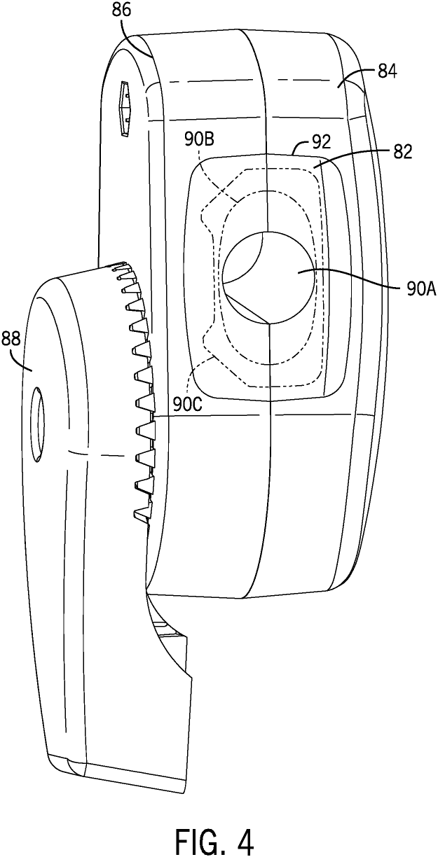

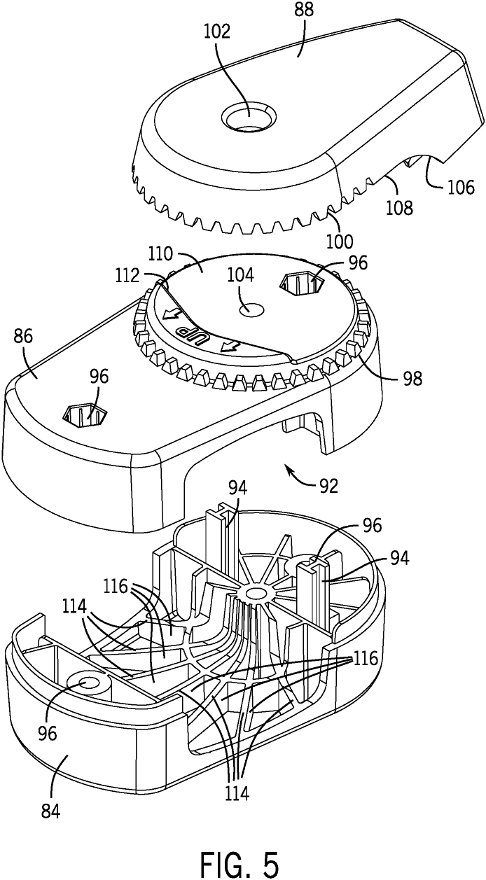

FIG. 4 is a perspective view of the clamp 80 as disclosed herein and FIG. 5 is an exploded view of the clamp 80. The clamp being 80 is configured to secure an arm 76 of the support frame 68 to a handle or an attachment point on a mower. As described in further detail herein, the clamp 80 uses a series of keyed clamp inserts 82, each keyed clamp insert 82 defining a bore 90 of a different profile to match any of a variety of handlebar or attachment point designs. The overall combination of clamp 80 as described herein, the support frame 68, the ball-and-socket joint 78, and the mounting bar 62 provide a grooming device 10 with the flexibility of configuration to be used with a wide variety of mowers and concurrently with a variety of mower accessories, while establishing and maintaining an orientation to the mower to achieve the intended aesthetic effect of striped lawn lines. In still further examples, the clamp 80 as disclosed herein may be used independently from the grooming device to mount one or more other lawn mower attachments or accessories to the lawn mower, including those noted above.

The clamp includes an inner shell 84, an outer shell 86, a movable clip 88, and the clamp inserts 82. In addition to FIGS. 4 and 5, FIG. 6 is an interior view of the inner shell 84, FIG. 7 is an interior view of the outer shell 86, and FIG. 8 is an interior view of the movable clip 88. The inner shell 84 and the outer shell 86 secure together by way of corresponding connection features 94 and aligned fastener through holes 96 which are sized and constructed to receive fasteners therethrough. The fasteners may exemplarily be threaded fasteners, for example a bolt and nut. The connected inner shell 84 and outer shell 86 form an insert cavity 92 dimensioned to receive any one of a plurality of keyed clamp inserts 82 therein. The keyed clamp inserts 82 will be described in further detail herein. The inner shell 84, outer shell, 86 and a clamp insert 82 are arranged about a handle or attachment point on a mower. The inner shell 84 and the outer shell 86 are secured together as described above, retaining the keyed clamp insert 82 in a fixed position about the handle or attachment point of the mower.

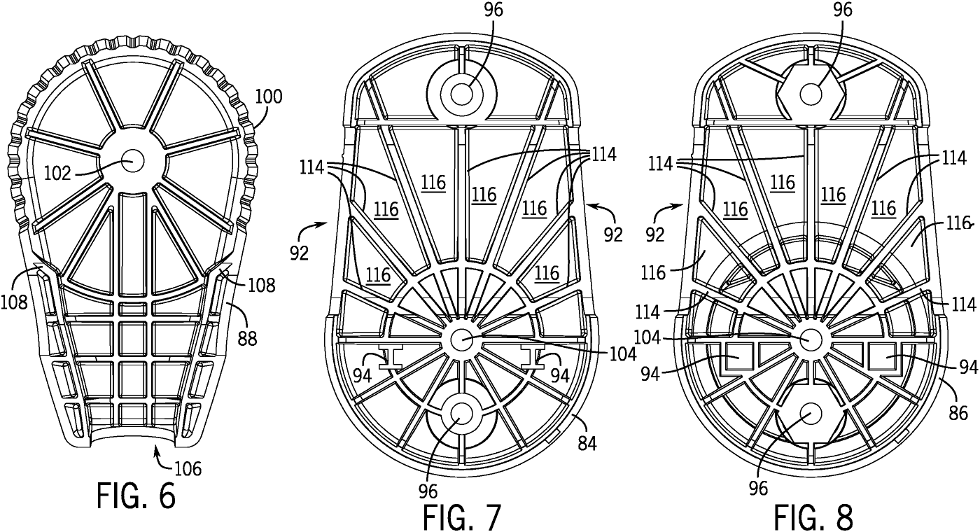

With additional reference to FIG. 6, the movable clip 88 further includes a channel 106 that is dimensioned and shaped to retain the arm 76 of the support frame 68. The connection between the movable clip 88 and the outer shell 86 provides the connection between the grooming device 10 and the mower.

The outer shell 86 includes a plurality of teeth 98 arranged in a circle on the outer surface of the outer shell 86. This plurality of teeth mesh with the plurality of teeth 100 on an interior edge of the movable clip 88. The movable clip 88 further includes interior corners 108 tangential to an arc of the plurality of teeth 100. The movable clip 88 is positioned with hole 102 aligned with hole 104 of the outer shell 86. A fastener, for example, a pin or a bolt is fitted through the holes 102, 104 to pivotably secure the movable clip 88 to the outer shell 86. In use, the fastener is loosened, permitting a freedom of rotation between the movable clip 88 and the outer shell 86 with the teeth defining increments of rotation. A recessed portion 110 defines a lip 112 on the outer surface of the outer shell 86 interior of the plurality of teeth 98. During relative rotation between the outer shell 86 and the movable clip 88, the interior corners 108 of the movable clip 88 abut the lip 112 of the outer shell 86 to limit the extent of relative rotation. fastener is then tightened to secure the relative positions of the outer shell 86 and the movable clip 88.

With reference to FIGS. 7 and 8, the interiors of the inner shell 84 and the outer shell 86 include a plurality of ribs 114 that extend radially outwards from the respective holes 104. These radially extending ribs 114 define a plurality of recesses 116 therebetween. Because the holes 104 are offset within the respective inner shell 84 and outer shell 86, and the holes 104 are positioned outside of the insert cavity 92, the ribs 114 are of different lengths and angles. The ribs 114 and recesses 116 there defined are symmetrical about the length of the inner shell 84 and the outer shell 86. Thus, the recesses 116 have different shapes, symmetrical about the lengths of the inner shell 84 and the outer shell 86. As will be detailed herein, these differently shaped recesses 116 extend across, and face into, the insert cavity 92, and thus define individual connections of the clamp inserts 82.

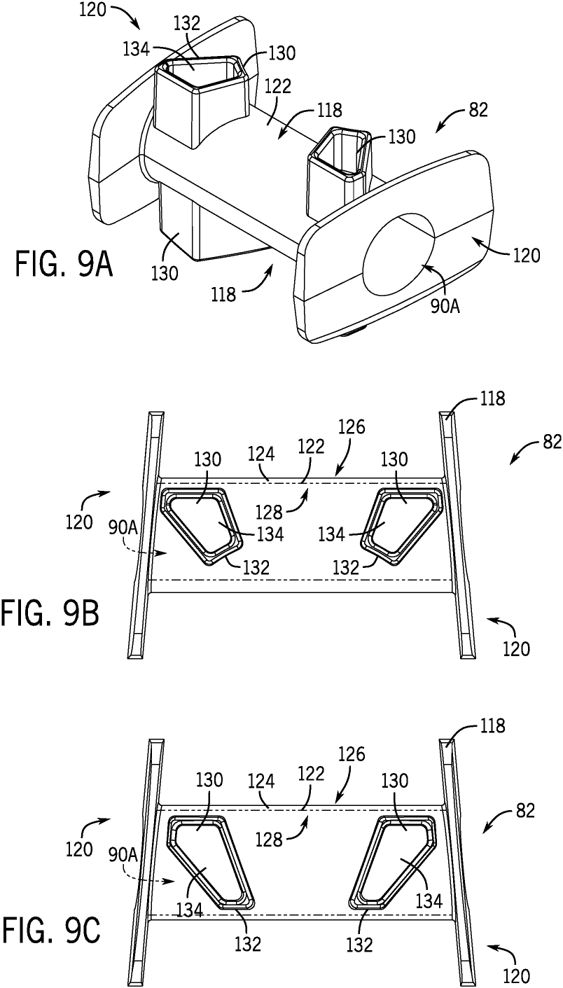

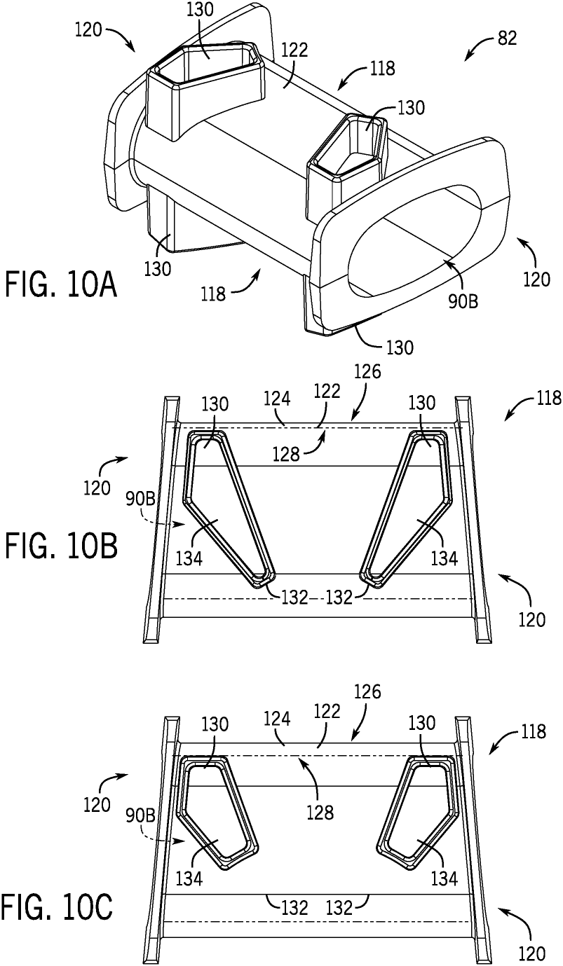

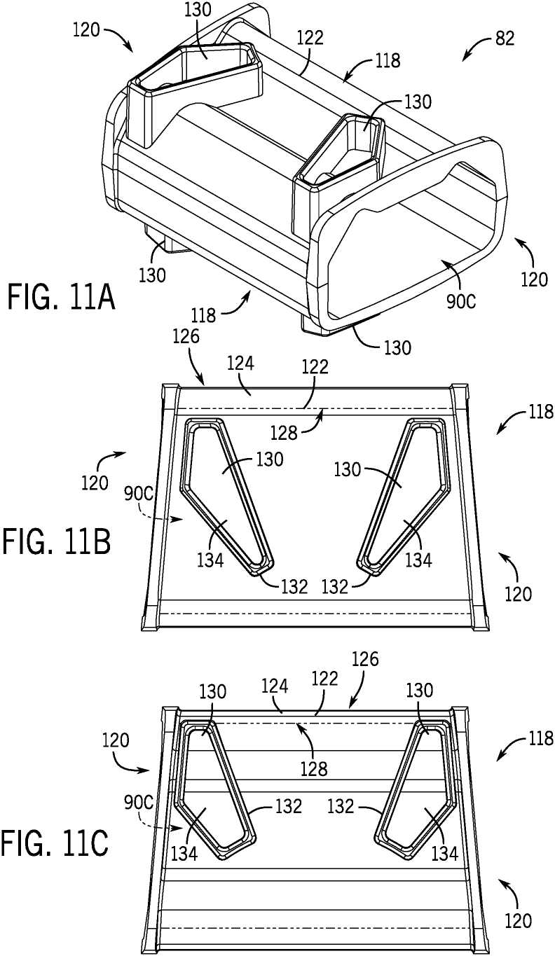

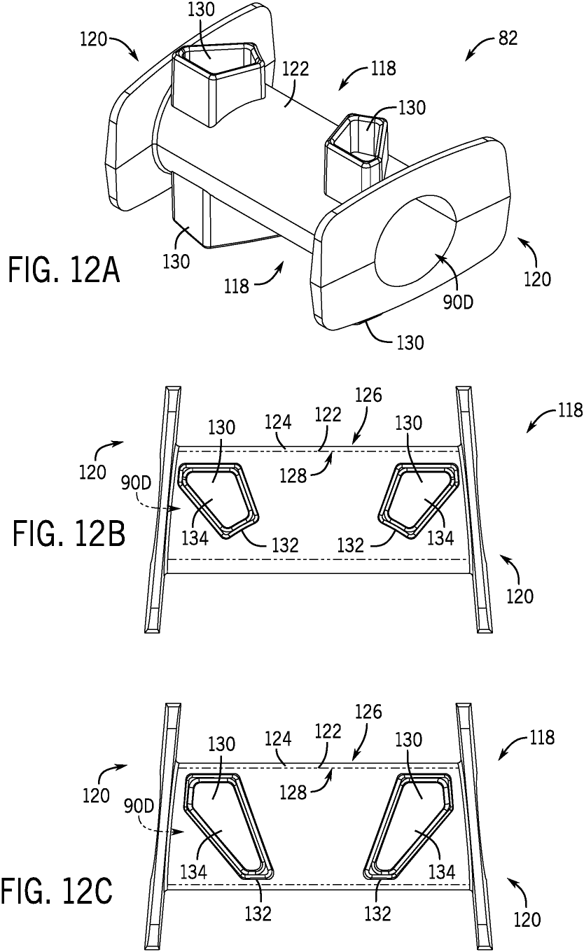

FIGS. 9-12 depict various examples of clamp inserts 82. The clamp inserts 82 each define an interior bore 90A-D (FIG. 4) having a different shape and configuration. While four examples of interior bores are provided in these figures, it will be recognized that other shapes or dimensions of interior bores are within the scope of the present disclosure as is needed to a mower handle or attachment point. The perimeters of the interior bores are different between each of the examples of the clamp inserts. These different perimeters of the interior bores configure each clamp insert to secure to a different shape of lawn mower handle. In this manner, the handle clamp can be customized to secure to any of a variety of lawn mower handle shapes by selection and use of a corresponding clamp insert.

Each clamp insert 82 is constructed of two insert portions 118. The clamp insert 82 defines faces 120 which are dimensioned to match the insert cavity 92 at the exterior surfaces of the inner shell 84 and the outer shell 86. An insert body 122 extends between the faces 120, the bore 90 defined between the faces 120 through the body 122. In examples, the body 122 includes a wall 124 with a thickness between an exterior body surface 126 and an interior surface 128 of the bore 90. In examples, the thickness of the wall 124 is consistent, thereby the exterior body surface 126 generally follows a contour of the interior surface 128 of the bore 90. This results in bodies 122 having differing volumes, generally corresponding to the respective bore 90, within the insert cavity 92.

Each insert portion 118 of each insert clamp 82 further includes at least one, and preferably two keyed projections 130. The keyed projections 130 are mirrors of each other on the same insert portion 118 and are different between the insert portions 118 of the insert clamp. The keyed projections 130 are contoured to be received within the recesses 116 of the inner shell 84 and the outer shell 86 when the insert clamp 82 is assembled within the inner shell 84 and the outer shell 86. The keyed projections 130 fit with a friction fit within the respective recesses 116. The keyed projections 130 may be constructed of a projection wall 132 defining a projection interior 134. Because the bodies 122 of each of the clamp inserts 82 have different dimensions and volumes, the keyed projections 130 that extend therefrom have different orientations to correspond to the recesses 116 adjacent to the body 122. In this manner, each different configuration of clamp insert 82 presents a different combination of keyed projections 130 such that the combination of shapes of keyed projections corresponds to a different configuration of interior bore 90A-D of the insert clamp 82.

Citations to several references are made herein. The cited references are incorporated by reference herein in their entireties. If there is an inconsistency between a definition of a term in the specification as compared to a definition of the term in a cited reference, the term should be interpreted based on the definition in the specification.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A grooming device for striping lawns, the grooming device comprising:
a cover;
a roller drum rotatably connected to the cover;
a frame connected to the cover and extending away from the cover; and
at least one clamp configured to adjustably conform to a cross-section of a handle of a lawn mower to secure the frame to the handle of a lawn mower.

2. The grooming device of claim 1, wherein the cover comprises a shroud, a first end, and a second end, wherein the first end and the second end are fittingly secured about the shroud.

3. The grooming device of claim 2, wherein the first end and the second end are translatable relative to the shroud to adjust a length between the first end and the second end to accommodate a length of the roller drum therebetween.

4. The grooming device of claim 2, further comprising a brush secured to the cover.

5. The grooming device of claim 4, wherein the cover comprises a leading edge facing in a normal direction of travel and comprises a trailing side opposite the leading edge; wherein the brush is secured at the trailing side of the cover.

6. The grooming device of claim 5, wherein the brush is movably connected to the cover such that a position of the brush relative to the cover is adjustable in the vertical dimension.

7. The grooming device of claim 6, further comprising a mounting bar to which the brush is secured and arms extend from the mounting bar, the arms pivotally connected to the cover.

8. The grooming device of claim 7, wherein the roller drum comprises axles that extend through the cover and the arms are pivotally connected to the cover about the axles.

9. The grooming device of claim 2, further comprising a ball-and-socket joint that movably connects the cover to the frame.

10. The grooming device of claim 2, further comprising:
a hitch receiver on the cover; and
a connector on a shank, wherein the shank is received within the hitch receiver and the connector secures to the frame.

11. The grooming device of claim 2, wherein the roller drum comprises a plurality of ridges extending across the outer surface of the roller drum in an axial length dimension.

12. The grooming device of claim 1, wherein the at least one clamp comprises an inner shell and an outer shell, wherein the inner shell and the outer shell secure together to define an insert cavity therebetween, and further comprising:
a plurality of clamp inserts, each clamp insert of the plurality of clamp inserts being configured to be individually secured within the insert cavity.

13. The grooming device of claim 12, wherein each clamp insert of the plurality of clamp inserts comprises keyed projections configured to be received within mating recesses formed in the inner shell and the outer shell.

14. The grooming device of claim 13, wherein each clamp insert comprises at least two insert portions wherein each insert portion comprises at least one keyed projection.

15. The grooming device of claim 8, wherein each clamp insert of the plurality of clamp inserts defines an interior bore, wherein a perimeter of the interior bore is different between each of the plurality of clamp inserts.

16. The grooming device of claim 11, wherein the at least one clamp further comprises a movable clip rotatably secured to the outer shell.

17. The grooming device of claim 16, wherein the movable clip and the outer shell each comprising mating teeth which releasably engage to secure the movable clip to the outer shell at an angular orientation.

18. A clamp for securing an accessory to a lawn mower, the clamp comprising:
an inner shell;
an outer shell, wherein the inner shell and the outer shell secure together to define an insert cavity therebetween;
a plurality of clamp inserts, each clamp insert of the plurality of clamp inserts being configured to be individually secured within the insert cavity, and wherein each clamp insert of the plurality of clamp inserts defines an interior bore, and a perimeter of the interior bore is different between each of the plurality of clamp inserts; and
a movable clip rotatably secured to the outer shell.

19. The clamp of claim 18, wherein each clamp insert of the plurality of clamp inserts comprises keyed projections configured to be received within mating apertures formed in the inner shell and the outer shell.

20. The clamp of claim 19, wherein each clamp insert comprises at least two insert portions wherein each insert portion comprises at least one keyed projection.
